(19) United States
(12) Patent Application Publication
(10) Pub. No.: US 2008/0292947 A1
(43) Pub. Date: Nov. 27, 2008

(54) Device for energy supply

(75) Inventor: Ernst Scherrer, Greifensee (CH)

Correspondence Address: THE WEBB LAW FIRM, P.C., 700 KOPPERS BUILDING, 436 SEVENTH AVENUE, PITTSBURGH, PA, 15219, US

(73) Assignee: MICRONEL AG, Tagelswangen (CH)

(21) Appl. No.: 11/983,837

(22) Filed: Nov. 13, 2007

(30) Foreign Application Priority Data
Nov. 14, 2006 (EP) 06 405 478.6

(51) Int. Cl. H01M 2/10

(52) U.S. Cl. 429/97

(57) ABSTRACT

The apparatus has a carrier for accommodating a plurality of series-connected energy cells, which each have a positive terminal and a negative terminal. An electrical contact is provided in the carrier for each terminal, which electrical contacts, when the energy cell is inserted, connect said energy cell to connection points for drawing energy. Each positive terminal and in each case the associated negative terminal are electrically connected to one another via a switch. These switches are designed such that they are in each case interrupted when an energy cell is inserted. The invention then also makes possible current consumption if fewer than the maximum possible number of energy cells are available.

The invention relates to an energy supply apparatus having a carrier for accommodating a plurality of series-connected energy cells, which each have a positive terminal and a negative terminal, an electrical contact being provided in the carrier for each terminal, which electrical contact, when the cell is inserted, connects said cell to connection points for drawing energy.

Apparatuses of this type are generally known for supplying electricity to electrical appliances. In order that the required voltage can be reached, two or more energy cells are connected in series. These energy cells, for example batteries or rechargeable batteries, are replaceable. The energy cells are in each case inserted into a compartment of a carrier or housing and in each case connected to connection points at the positive terminal and at the negative terminal therein, at which connection points the current can be drawn. A current can only be drawn or the appliance can only be used if in each case one energy cell has been inserted into all of the compartments. If the intended number of energy cells is not provided, such an appliance cannot be used. Use is also not possible when only one energy cell cannot be replaced. The reliability of such appliances is therefore restricted. In numerous appliances, for example in life support appliances, however, a very high degree of reliability is essential. An apparatus which can be equipped with a variable number of energy cells and can in each case be used as an energy source would therefore be desirable. U.S. Pat. No. 5,954,420 has disclosed a tubular torch, which has a housing for accommodating a plurality of batteries. The torch can be operated with different numbers of batteries. For this purpose, it has a housing which is telescopically adjustable in terms of its length. Depending on the number of batteries inserted into the housing, the housing is extended or shortened. In order that electrical contact is ensured in each case, when the length is adjusted a contact part is displaced correspondingly. The lamp can therefore also be operated when, for example, only two batteries are available instead of the four intended batteries. The telescopic adjustability provided here is not possible or not expedient in many appliances, however.

The invention is based on the object of providing an apparatus of the mentioned type which can be equipped and used with a variable number of energy cells.

The object is achieved in an apparatus of the generic type by virtue of the fact that each positive terminal and the associated negative terminal are each electrically connected to one another via a switch, and this switch is designed such that it is interrupted when an energy cell is inserted. If in the case of such an apparatus a battery is missing, the unused positive terminal and the corresponding negative terminal are bridged by the switch. The apparatus therefore produces a voltage even when the maximum intended number of energy cells has not been inserted. When inserting a battery, the corresponding switch is interrupted and the bridging of the terminals in this case takes place by means of the energy cell. Preferably, at least one switch is designed such that it is automatically interrupted when the energy cell is inserted. The insertion and replacement of the energy cells is therefore as simple as in previously conventional apparatuses.

The apparatus can be produced in a very simple and cost-effective manner if, in accordance with a development of the invention, the switches each have a spring-elastic element, which moves when the corresponding energy cell is inserted and, as a result, the switching contact is interrupted. The spring-elastic element may be, for example, a spring-elastic tongue, which, when the corresponding energy cell is inserted, is pivoted into a position in which the contact is interrupted.

In accordance with a development of the invention, the apparatus has a voltage converter and in particular a step-down or step-up voltage converter. This can ensure that, even with a variable number of energy cells, in each case substantially the same constant voltage is provided.

The apparatus is intended in particular for an appliance which has a fan, which is operated by this apparatus. The fan in this case serves as, for example, a respiratory aid in a protective mask. The reliability of such an appliance can be substantially increased by the use of the apparatus according to the invention.

Exemplary embodiments of the invention will be explained in more detail below with reference to the drawing, in which:

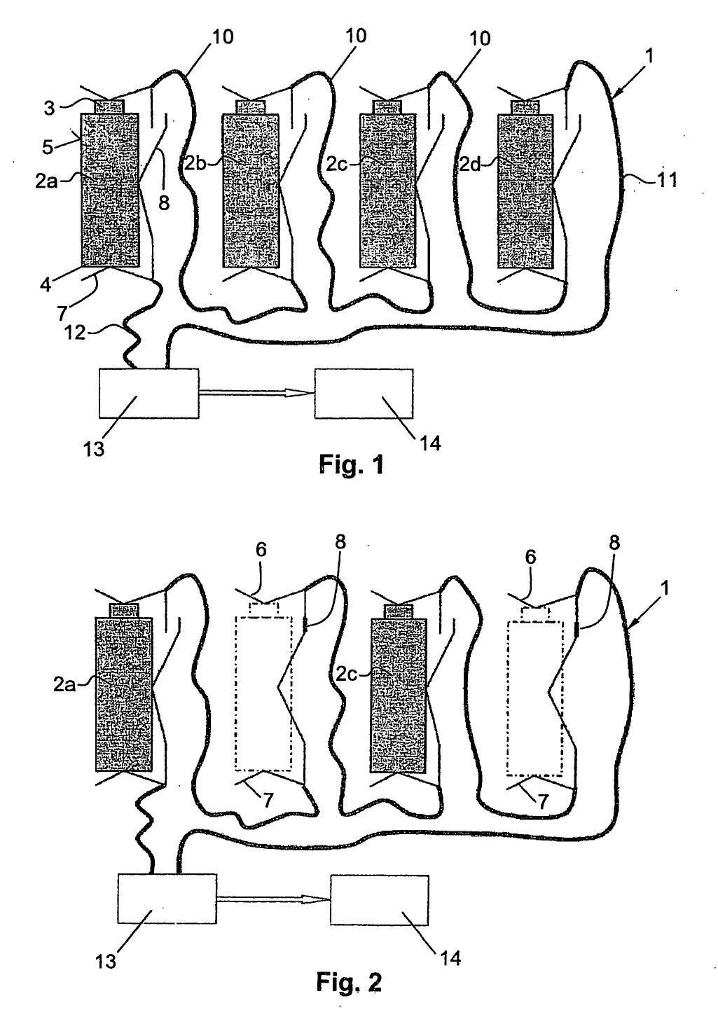

FIG. 1 shows, schematically, an apparatus according to the invention, the maximum number of energy cells being inserted,

FIG. 2 shows the apparatus shown in FIG. 1, but with fewer energy cells,

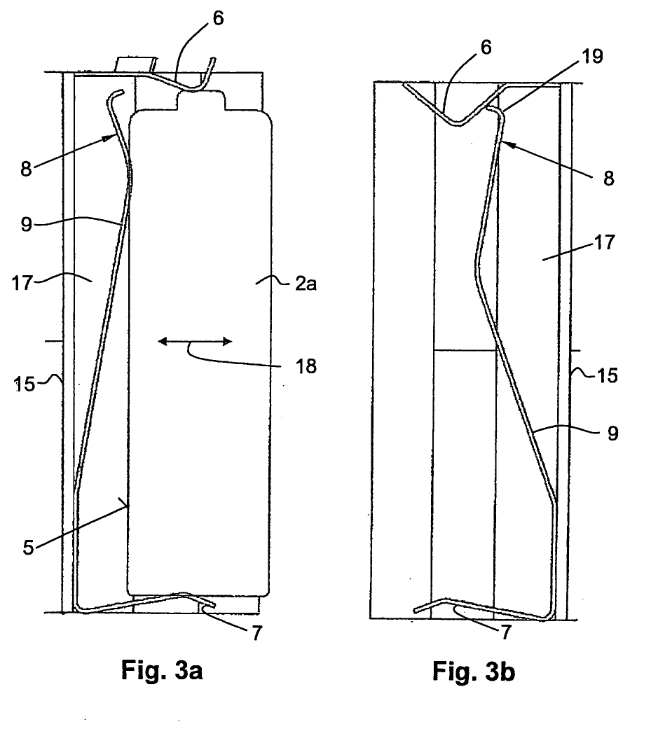

FIG. 3a shows, schematically, a battery,

FIG. 3b shows the battery compartment shown in FIG. 3a, but without the battery,

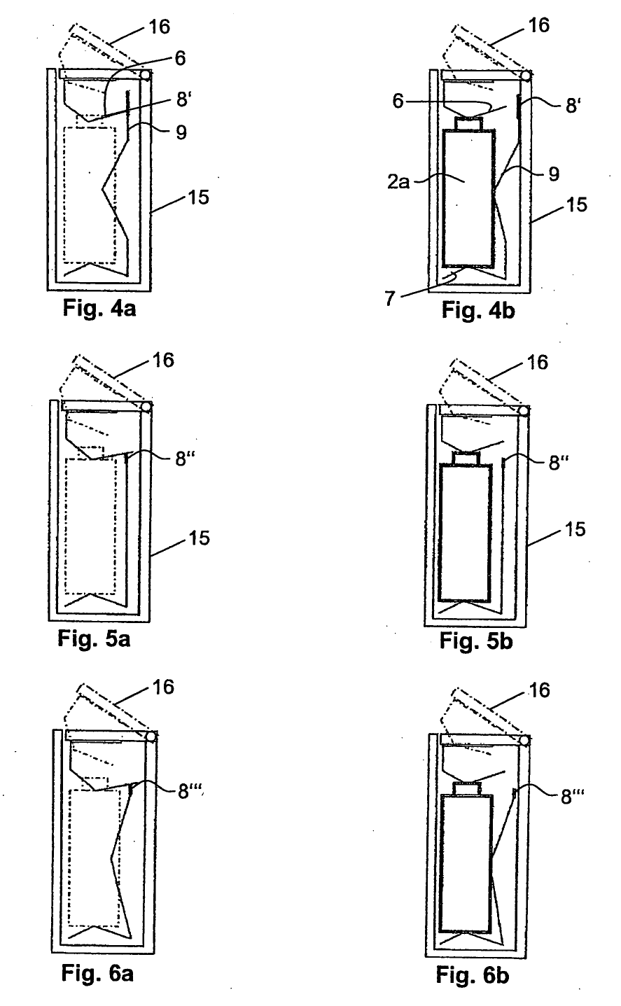

FIG. 4a shows, schematically, a battery compartment in accordance with a variant, but without a battery,

FIG. 4b shows the battery compartment shown in FIG. 4a, but with a battery inserted,

FIG. 5a shows a further variant of an energy compartment without a battery,

FIG. 5b shows the battery compartment shown in FIG. 5a, but with a battery inserted,

FIG. 6a shows a further variant of a battery compartment without a battery,

FIG. 6b shows the battery compartment shown in FIG. 6a, but with a battery inserted,

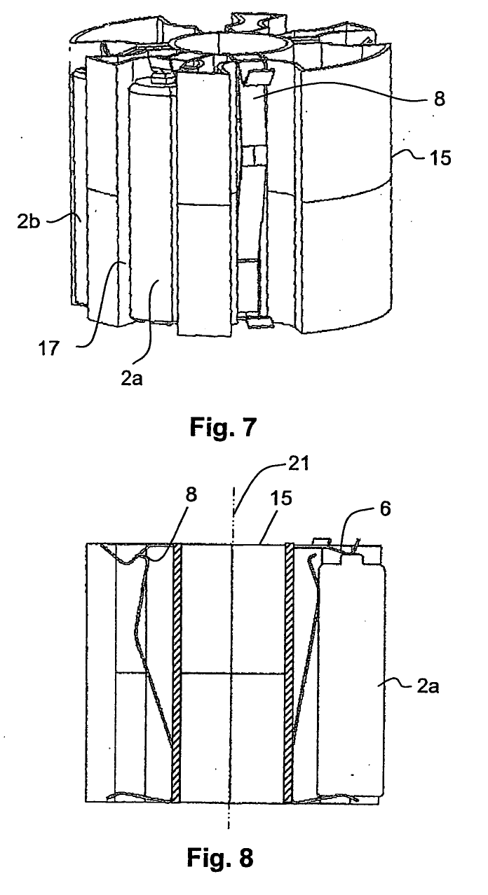

FIG. 7 shows, schematically, a three-dimensional view of an apparatus according to the invention in accordance with a further variant, and

FIG. 8 shows an axial section through the apparatus shown in FIG. 7.

FIG. 1 shows an apparatus 1 according to the invention, which is provided with four batteries 2a, 2b, 2c and 2d. Instead of these batteries, other energy cells, for example rechargeable batteries or the like, can also be provided. The batteries 2a-2d are connected in series and each have a first terminal 3, which is, for example, the positive terminal and a second terminal 4, which is, for example, the negative terminal, in a manner known per se. The first terminal 3 is contact-connected to a first contact element 6, and the second terminal 4 is in each case contact-connected by means of a second contact element 7. In order to conduct a current from the series-connected batteries 2a-2d, electrical conductors 10, 11, and 12 are provided, which are connected to a voltage converter 13. Instead of this voltage converter 13, the electrical conductors 12 and 11 can, however, also be connected directly or via a connector to the electrical load.

FIG. 2 shows the apparatus 1 shown in FIG. 1, in this case only the batteries 2a and 2c having been inserted. The batteries 2b and 2d are missing here, however. Instead of the missing batteries, in each case one switch 8 connects the first contact element 6 to the second contact element 7. With the batteries 2a and 2c inserted, these contact elements 6 and 7 are in each case connected to one another via the batteries 2a and 2c, respectively, since in this case the corresponding switch 8 has been interrupted, as can be seen.

FIG. 3a shows on an enlarged scale a battery compartment 17 in a carrier 15, which has a plurality of such compartments 17, such as, for example, the carrier shown in FIGS. 7 and 8. The battery 2a with which electrical contact has been made by the first contact element 6 and the second contact element 7 has been inserted into the compartment 17. The switch 8 has in this case been interrupted, as is shown. The first contact element 6 is therefore connected to the electrical conductor 10 and the second contact element 7 is connected to the electrical conductor 12. The switch 8 is open since a spring-elastic switching contact part 9 bears in a spring-elastic manner against an outer surface 5 of the battery 2a and is therefore held in an open position.

In FIG. 3a, the battery 2a is inserted or removed in the directions of the double arrow 18. When the battery 2 is removed, the switching contact part 9, owing to its stress, pivots into the position shown in FIG. 3b and an upper end 19 thereof makes contact with the first contact element 6. The switching contact part 9 is still stressed, with the result that the mentioned end 19 is in constant contact with the first contact element 6. The switch 8 is therefore now closed, and the first contact element 6 is electrically connected to the second contact element 7 via the switching contact part 9. If a battery 2a is again inserted into the compartment 17, the switching contact part 9 is moved transversely with respect to the longitudinal direction of the battery 2a into the position shown in FIG. 3a in which the switch 8 is open again.

FIGS. 4a and 4b show a switch 8′ in accordance with a variant. In this case, a first contact element 6′ is arranged on a pivotable cover 16. When the cover 16 is open, as shown in FIG. 4b the battery 2a can be inserted and removed in the directions of the double arrow 20 and therefore in the longitudinal direction of the battery 2a. When the compartment 17′ is empty, a switching contact part 19′ is stressed against the first contact element 6′, and therefore the switch 8′ is closed. When the battery 2a is inserted, as shown in FIG. 4b the switch 8′ is open.

FIGS. 5a and 5b show a switch 8″ in accordance with a further variant. In this case, too, a cover 16 is provided, on which the abovementioned, first contact element 6′ is arranged. When the switch 8″ is closed, this first contact element 6′ shown in FIG. 5a is stressed against a switching contact part 9″. When the battery 2a is inserted, the first contact element 6′ is lifted off from this switching contact part 9″ and the switch 8″ is therefore open. The switching contact part 9″ is not moved in this variant and remains in the extended arrangement shown.

FIGS. 6a and 6b show a further variant of a switch 8′″. The switching contact part 9′″ provided here is likewise kinked or bent in a central region 9a, as is the switching contact part 9′ shown in FIGS. 4a and 4b. The switching contact part 9′″ in this case, however, bears with its upper end against the underside of the first contact element 6′ if no battery has been inserted into the compartment 17′, as is shown in FIG. 6a. When the battery 2a is inserted into the compartment 17′, the switching contact part 19″ is pivoted laterally transversally with respect to the longitudinal direction of the battery 2a. Once the cover 16 has been closed, the first contact element 6′ is in a raised, stressed position, and therefore the switch 8′″ is opened, as can be seen.

The switches 8, 8′, 8″ and 8′″ shown are only some of several possible exemplary embodiments of a switch which are expedient in this case and which make it possible for the switch to be opened automatically when the battery is inserted and to be closed again automatically when the battery is removed.

FIGS. 7 and 8 show a specific embodiment of the apparatus 1 according to the invention. The carrier 15 is in this case in the form of a barrel magazine, which can be mounted in a housing (not shown here) of an appliance in such a way that it is capable of rotating about an axis 21. The carrier 15 has six compartments 17. Here, in each case one battery 2a or 2b is inserted into two of these compartments 17. The insertion in this case takes place radially. In principle, however, in this case an axial insertion or removal is also possible. The abovementioned voltage converter 13 is not illustrated here and can be arranged in a circuit of the appliance 14. The batteries 2a and 2b can be conventional batteries, for example alkaline batteries, nickel-cadmium batteries or lithium batteries with a voltage of in each case, for example, 1.5 volts or 1.2 volts. Other voltages are naturally also conceivable. In the case of a series circuit even with empty compartments 17, a voltage, for example of 6 volts, can therefore be kept constant with the mentioned voltage converter 13, even in the case of a falling or varying cell voltage. Preferably, six compartments 17 are each provided with a switch 8. These switches can also be designed such that the energy cells 2a and 2b can inserted axially. An embodiment is also conceivable in which not all of the compartments 17 are provided with a switch 8. For example, three compartments 17 as have been conventional to date and three compartments 17 in accordance with the invention could in each case be provided with one switch 8. Instead of the cylindrical arrangement of the energy cells in a barrel magazine, another arrangement is also conceivable, for example an arrangement in one plane.

### LIST OF REFERENCE SYMBOLS

1 apparatus
2 energy cell
3 first terminal
4 second terminal
outer surface
6 first contact element
7 second contact element
8 switch
9 switching contact part
10 electrical conductor
11 electrical conductor
12 electrical conductor
13 voltage converter
14 appliance
15 carrier
16 cover
17 compartment
18 double arrow
19 upper end
20 double arrow
21 axis

1: An energy supply apparatus having a carrier for accommodating a plurality of series-connected energy cells, which each have a positive terminal and a negative terminal, an electrical contact being provided in the carrier for each terminal, which electrical contacts when the energy cell has been inserted, connect said energy cell to connection points for drawing energy, wherein each positive terminal and in each case the associated negative terminal are electrically connected to one another via a switch, and this switch is designed such that it is interrupted when an energy cell is inserted.

2: The apparatus as claimed in claim 1, wherein the switch is automatically interrupted when an energy cell is inserted.

3: The apparatus as claimed in claim 1, wherein the switch in each case has a spring-elastic part, which is moved, when an energy cell is inserted, into a position in which the switching contact of the switch is interrupted.

4: The apparatus as claimed in claim 1, wherein the carrier is in the form of a revolver magazine.
